(19) United States
(12) Patent Application Publication
(10) Pub. No.: US 2025/0088453 A1
(43) Pub. Date: Mar. 13, 2025

(54) ADAPTIVE ROUTING FOR POWER-EFFICIENT SWITCHING

(71) Applicant: MELLANOX TECHNOLOGIES, LTD., Yokneam (IL)

(72) Inventors: Eran Gil Beracha, Tel Aviv (IL); Amit Kazimirsky, Tel Aviv (IL); Aviv Kfir, Nili (IL); Ilya Vershkov, Rishon LeZion (IL); Roee Levy Leshem, Tel Aviv (IL); Tal Mund, Herzliya (IL); Liron Mula, Herzliya (IL)

(21) Appl. No.: 18/244,818

(22) Filed: Sep. 11, 2023

(51) Int. Cl. H04L 45/125; H04L 45/00; H04L 45/12

(52) U.S. Cl. CPC H04L 45/125; H04L 45/124; H04L 45/70

(57) ABSTRACT

A device, communication system, and method are provided. In one example, a system for routing traffic is described that includes a plurality of ports to facilitate communication over a network. The system also includes a controller to determine, for a first port of a plurality of ports, a bandwidth for the first port and a bandwidth history for the first port, compare the bandwidth for the first port and the bandwidth history for the first port to a threshold, and alter a configuration of the first port based on the comparing of the bandwidth and the bandwidth history to the threshold.

### FIELD OF THE DISCLOSURE

The present disclosure is generally directed toward networking and, in particular, toward networking devices, switches, and methods of operating the same.

### BACKGROUND

Switches and similar network devices represent a core component of many communication, security, and computing networks. Switches are often used to connect multiple devices, device types, networks, and network types.

Devices including but not limited to personal computers, servers, or other types of computing devices, may be interconnected using network devices such as switches. These interconnected entities form a network that enables data communication and resource sharing among the nodes. Often, multiple potential paths for data flow may exist between any pair of devices. This feature, often referred to as multipath routing, allows data, often encapsulated in packets, to traverse different routes from a source device to a destination device. Such a network design enhances the robustness and flexibility of data communication, as it provides alternatives in case of path failure, congestion, or other adverse conditions. Moreover, it facilitates load balancing across the network, optimizing the overall network performance and efficiency. However, managing multipath routing and ensuring optimal path selection can pose significant challenges, necessitating advanced mechanisms and algorithms for network control and data routing, and power consumption may be unnecessarily high, particularly during periods of low traffic.

### BRIEF SUMMARY

In accordance with one or more embodiments described herein, a computing system, such as a switch, may enable a diverse range of systems, such as switches, servers, personal computers, and other computing devices, to communicate across a network. Ports of the computing system may function as communication endpoints, allowing the computing system to manage multiple simultaneous network connections with one or more nodes.

Each port of the computing system may be considered a lane and may be associated with an egress queue of data, such as in the form of packets, waiting to be sent via the port. In effect, each port may serve as an independent channel for data communication to and from the computing system. Each port of the computing system may be connected to one or more ports of one or more other computing systems. Ports allow for concurrent network communications, enabling the computing system to engage in multiple data exchanges with different network nodes simultaneously.

As described herein, ports of a computing system may be selectively activated or deactivated. Deactivating a port may comprise, as described in greater detail below, directing data to another port which leads to a same destination as the deactivated port by placing the data in a queue associated with the other port. In other words, deactivating a particular port may comprise determining whether a packet to be sent to a destination should be sent via another port and, in response to the determination, storing the packet in a queue associated with the other port.

As described herein, ports of a computing system may be selectively activated or deactivated based on a number of factors. Such factors, as described in greater detail below, may include a current bandwidth of a particular port, a bandwidth history of the port, a utilization of a buffer of the system, a system activity (e.g., a percentage of ports of the system which are currently active), and/or other factors.

The present disclosure discusses a system and method for enabling a switch or other computing system to activate or deactivate one or more ports based on a number of such factors. Embodiments of the present disclosure aim to solve the above-noted shortcomings and other issues by implementing an improved routing approach. Systems and methods as described herein reduce power consumption while avoiding data speed issues.

The routing approach depicted and described herein may be applied to a switch, a router, or any other suitable type of networking device known or yet to be developed. In an illustrative example, a system is disclosed that includes circuits to provide adaptive routing, the circuits to determine, for a first port of a plurality of ports, a bandwidth for the first port and a bandwidth history for the first port; compare the bandwidth for the first port and the bandwidth history for the first port to one or more thresholds; and alter a configuration of the first port based on the comparing of the bandwidth and the bandwidth history to the one or more thresholds.

In another example, a system is disclosed that includes one or more circuits to alter a configuration of a first port of a plurality of ports based on a comparison of a bandwidth of the first port, a bandwidth history of the first port, a buffer utilization of the computing system, and a system activity associated with the plurality of ports to one or more thresholds.

In yet another example, a switch is disclosed that includes one or more circuits to determine a system activity and a buffer utilization; determine, for each of a plurality of ports, a bandwidth and a historical bandwidth; compare, for each of the plurality of ports, the bandwidth, the historical bandwidth, the buffer utilization, and the system activity to one or more thresholds; and transmit a packet via one of the plurality of ports based on the comparing, for each of the plurality of ports, of the bandwidth, the bandwidth history, the buffer utilization, and the system activity to the one or more thresholds.

Any of the above example aspects include wherein altering the configuration of the first port results in a change in power consumption of the system.

Any of the above example aspects include wherein the configuration of the first port comprises one or more of a score and a grade of the first port, and wherein altering the configuration of the first port comprises changing the one or more of the score and the grade of the first port. Any of the above example aspects include wherein altering the configuration of the first port comprises disabling the first port.

Any of the above example aspects include wherein altering the configuration of the first port comprises enabling the first port.

Any of the above example aspects include determining a system activity, wherein the system activity is a percentage of active ports.

Any of the above example aspects include wherein the bandwidth history for the first port comprises a moving weighted average.

Any of the above example aspects include wherein comparing the bandwidth for the first port and the bandwidth history for the first port to one or more thresholds comprises determining a sum of the bandwidth for the first port, the bandwidth history for the first port, a buffer utilization, and a system activity is below one of the one or more thresholds.

Any of the above example aspects include wherein in response to determining the sum of the bandwidth for the first port, the bandwidth history for the first port, the buffer utilization, and the system activity is below one of the one or more thresholds, adjusting the configuration of the first port comprises disabling the first port.

Any of the above example aspects include wherein comparing the bandwidth for the first port and the bandwidth history for the first port to one or more thresholds comprises determining a sum of the bandwidth for the first port, the bandwidth history for the first port, a buffer utilization, and a system activity is above one of the one or more thresholds.

Any of the above example aspects include wherein in response to determining the sum of the bandwidth for the first port, the bandwidth history for the first port, the buffer utilization, and the system activity is above one of the one or more thresholds, adjusting the configuration of the first port comprises enabling the first port.

Any of the above example aspects include wherein the first port is selected from among the plurality of ports using a round robin algorithm.

Any of the above example aspects include wherein a respective configuration of each of the plurality of ports is altered consecutively in a loop.

Any of the above example aspects include wherein after altering the respective configuration of each of the plurality of ports a sleep time elapses before the respective configuration of each of the plurality of ports is re-altered.

Any of the above example aspects include wherein the one or more circuits are further to: determine, for a second port of the plurality of ports, a bandwidth for the second port and a bandwidth history for the second port; compare the bandwidth for the second port and the bandwidth history for the second port to the one or more thresholds; and adjust a configuration of the second port based on the comparing of the bandwidth for the second port and the bandwidth history for the second port to the one or more thresholds.

Any of the above example aspects include wherein each of the plurality of ports are eligible for adaptive routing.

Any of the above example aspects include wherein the one or more circuits are further to send a packet via one of the ports of the plurality of ports based at least in part on a grade of each of the ports.

Any of the above example aspects include wherein the one or more circuits are further to determine a system activity and a buffer utilization, and wherein altering the configuration of the first port is further based on a comparison of the system activity and the buffer utilization to the one or more thresholds.

Additional features and advantages are described herein and will be apparent from the following Description and the figures.

### BRIEF DESCRIPTION OF THE SEVERAL VIEWS OF THE DRAWINGS

The present disclosure is described in conjunction with the appended figures, which are not necessarily drawn to scale:

FIG. 1 is a block diagram depicting an illustrative configuration of a computing system in accordance with at least some embodiments of the present disclosure;

FIG. 2 illustrates a network of a computing system and nodes in accordance with at least some embodiments of the present disclosure;

FIG. 3 illustrates a network of computing systems and nodes in accordance with at least some embodiments of the present disclosure;

FIG. 4 illustrates a network of computing systems and nodes in accordance with at least some embodiments of the present disclosure;

FIG. 5 is a flow diagram depicting a method in accordance with at least some embodiments of the present disclosure; and

FIG. 6 is a flow diagram depicting a method in accordance with at least some embodiments of the present disclosure.

### DETAILED DESCRIPTION

The ensuing description provides embodiments only, and is not intended to limit the scope, applicability, or configuration of the claims. Rather, the ensuing description will provide those skilled in the art with an enabling description for implementing the described embodiments. It is understood that various changes may be made in the function and arrangement of elements without departing from the spirit and scope of the appended claims.

It will be appreciated from the following description, and for reasons of computational efficiency, that the components of the system can be arranged at any appropriate location within a distributed network of components without impacting the operation of the system.

Furthermore, it should be appreciated that the various links connecting the elements can be wired, traces, or wireless links, or any appropriate combination thereof, or any other appropriate known or later developed element(s) that is capable of supplying and/or communicating data to and from the connected elements. Transmission media used as links, for example, can be any appropriate carrier for electrical signals, including coaxial cables, copper wire and fiber optics, electrical traces on a printed circuit board (PCB), or the like.

As used herein, the phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means: A alone, B alone, C alone, A and B together, A and C together, B and C together, or A, B and C together.

The term “automatic” and variations thereof, as used herein, refers to any appropriate process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The terms “determine,” “calculate,” and “compute,” and variations thereof, as used herein, are used interchangeably, and include any appropriate type of methodology, process, operation, or technique.

Various aspects of the present disclosure will be described herein with reference to drawings that are schematic illustrations of idealized configurations.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and this disclosure.

As used herein, the singular forms “a,” “an,” and “the” are intended to include the plural forms as well, unless the context clearly indicates otherwise. It will be further understood that the terms “comprise,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof. The term “and/or” includes any and all combinations of one or more of the associated listed items.

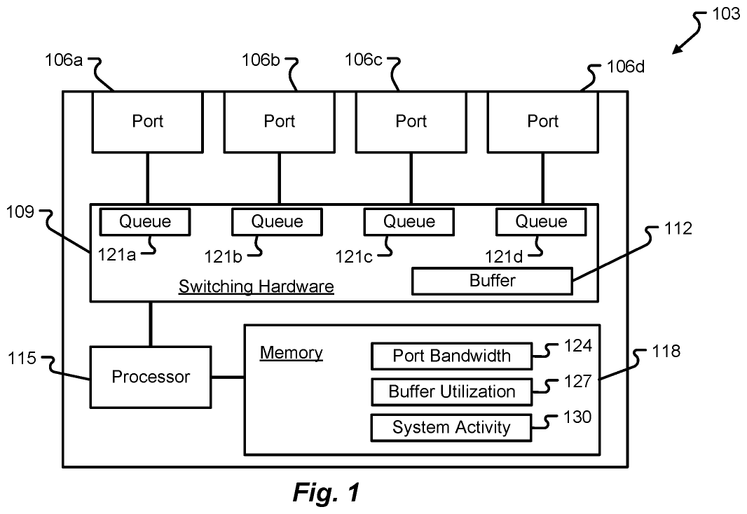

Referring now to FIGS. 1-6, various systems and methods for routing packets between communication nodes will be described. The concepts of packet routing depicted and described herein can be applied to the routing of information from one computing device to another. The term packet as used herein should be construed to mean any suitable discrete amount of digitized information. The information being routed may be in the form of a single packet or multiple packets without departing from the scope of the present disclosure. Furthermore, certain embodiments will be described in connection with a system that is configured to make centralized routing decisions whereas other embodiments will be described in connection with a system that is configured to make distributed and possibly uncoordinated routing decisions. It should be appreciated that the features and functions of a centralized architecture may be applied or used in a distributed architecture or vice versa.

In accordance with one or more embodiments described herein, a computing system 103 as illustrated in FIG. 1 may enable a diverse range of systems, such as switches, servers, personal computers, and other computing devices, to communicate across a network. Such a computing system 103 as described herein may for example be a switch or any computing device comprising a plurality of ports 106a-d for connecting with nodes on a network.

The ports 106a-d of the computing system 103 may function as communication endpoints, allowing the computing system 103 to manage multiple simultaneous network connections with one or more nodes. Each port 106a-d may be used to transmit data associated with one or more flows. Each port 106a-d may be associated with a queue 121a-d enabling the port 106a-d to handle incoming and outgoing data packets associated with flows.

Each port 106a-d of the computing system may be considered a lane and be associated with a respective egress queue 121a-d of data, such as in the form of packets, waiting to be sent via the port 106a-d. In effect, each port 106 may serve as an independent channel for data communication to and from the computing system 103. Ports 106 allow for concurrent network communications, enabling the computing system 103 to engage in multiple data exchanges with different network nodes simultaneously. As a packet or other form of data becomes ready to be sent from the computing system 103, the packet may be assigned to a port 106 from which the packet will be sent by being stored in a queue 121 associated with the port 106.

The ports 106a-d of the computing system 103 may be physical connection points which allow network cables such as Ethernet cables to connect the computing system 103 to one or more network nodes. Each port 106a-d may be of a different type, including, for example, a 100 Mbps, 1000 Mbps, or 10-Gigabit Ethernet ports, each providing different levels of bandwidth.

As described herein, ports 106a-d of a computing system 103 may be selectively activated or deactivated. Deactivating a port 106a-d may comprise, as described in greater detail below, directing data to another port 106a-d which leads to a same destination as the deactivated port 106a-d by placing the data in a queue 121a-d associated with the other port 106a-d. Activating a port 106a-d may comprise, as described in greater detail below, directing data to the port 106a-d by placing the data in a queue 121a-d associated with the port 106a-d.

As described herein, a particular port 106 of a computing system 103 may be selectively activated or deactivated based on a number of factors. Such factors may include, for example, a current bandwidth of the port 106. Bandwidth of a port 106 may be a number of packets stored in a queue 121 associated with the port 106 or may be a number associated with an amount of traffic sent via the port 106 over a time period, such as within the previous second. Bandwidth of ports 106a-d may be stored as port bandwidth data 124 in memory 118 of the computing system. For example, a processor 115 of the computing system may poll the bandwidth of each port 106a-d and store the bandwidth in memory 118. Polling bandwidth of ports 106a-d may in some implementations comprise reading an amount of data in each queue 121a-d or by tracking an amount of data written to and/or read from each queue 121a-d.

Factors used to determine whether a particular port 106 should be activated or deactivated may also include a bandwidth history of the port 106. For example, port bandwidth data 124 for each port 106 may be tracked over time. In some implementations, calculations may be made to determine trends or other statistics relating to port bandwidth history. For example, a weighted-moving-average may be calculated. Bandwidth history for each port may be determined over a given time period or over the life of the computing system 103. Determining bandwidth history may be performed by the processor 115 of the system 103 such as by reading an amount of data stored in each queue 121, an amount of data written to and/or read from each queue 121, and/or port bandwidth data 124 stored in the memory 118 and making calculations based on the data.

Factors used to determine whether a particular port 106 should be activated or deactivated may also include buffer utilization of a buffer 112 of the system 103. Buffer utilization data 127 may be stored in memory 118 of the system 103. Buffer utilization may be a current amount of data stored in the buffer 112 or may be a percentage of the capacity of the buffer 112 which is currently occupied. The data stored in the buffer 112 may be data waiting to be assigned to a port 106 by being written to or stored in a queue 121. Buffer utilization data 127 may be created by the processor 115 such as by reading an amount of data stored in the buffer 112 or by tracking data written to and/or read from the buffer 112 and making calculations based on the data.

Factors used to determine whether a particular port 106 should be activated or deactivated may also include a measurement or representation of system activity. System activity data 130 may be stored in memory 118. System activity may be a percent of currently active ports 106a-d of the system. For example, the processor 115 of the system 103 may divide a current number of active ports 106a-d by a total number of ports 106a-d.

While the above-discussed calculations are described as being made by a processor 115 and stored in memory 118, it should be appreciated that in some implementations, such calculations may be made by hardware circuitry forming logic configured to make the calculations necessary. Furthermore, results of such calculations need not be stored in memory 118 and may instead be made on-the-fly as needed when a determination as to whether any ports should be activated or deactivated is made.

Switching hardware 109 of the computing system may comprise an internal fabric or pathway within the computing system 103 through which data travels between two ports 106a-d. The switching hardware 109 may in some embodiments comprise one or more network interface cards (NICs). For example, in some embodiments, each port 106a-d may be associated with a different NIC. The NIC or NICs may comprise hardware and/or circuitry which may be used to transfer data between ports 106a-d.

Switching hardware 109 may also or alternatively comprise one or more application-specific integrated circuits (ASICs) to perform tasks such as determining to which port a received packet should be sent. The switching hardware 109 may comprise various components including, for example, port controllers that manage the operation of individual ports, network interface cards that facilitate data transmission, and internal data paths that direct the flow of data within the computing system 103. The switching hardware 109 may also include memory elements to temporarily store data and management software to control the operation of the hardware. This configuration could enable the switching hardware 109 to accurately track port usage and provide data to the processor 115 upon request.

Packets received by the computing system 103 may be placed in a buffer 112 until being placed in a queue 121a-d before being transmitted by a respective port 106a-d. The buffer 112 may effectively be an ingress queue where received data packets may temporarily be stored. As described herein, the ports 106a-d via which a given packet is to be sent may be determined based on a number of factors.

As illustrated in FIG. 1, the computing system 103 may also comprise a processor 115, such as a CPU, a microprocessor, or any circuit or device capable of reading instructions from memory 118 and performing actions. The processor 115 may execute software instructions to control operations of the computing system 103.

The processor 115 may function as the central processing unit of the computing system 103 and is fundamental to executing the system's operative capabilities. Processor 115 communicates with other components of the computing system 103 to manage and perform computational operations, ensuring optimal system functionality and performance.

In further detail, the processor 115 may be engineered to perform a wide range of computational tasks. Capabilities of the processor may encompass executing program instructions, managing data within the system, and controlling the operation of other hardware components such as switching hardware 109. The processor 115 may be a single-core or multi-core processor and might include one or more processing units, depending on the specific design and requirements of the computing system 103. The architectural design of the processor 115 may allow for efficient instruction execution, data processing, and overall system management, thereby enhancing the computing system 103's performance and utility in various applications. Furthermore, the processor 115 may be programmed or adapted to execute specific tasks and operations according to application requirements, thus potentially enhancing the versatility and adaptability of the computing system 103.

The computing system 103 may further comprise one or more memory 118 components. Memory 118 may be configured to communicate with the processor 115 of the computing system 103. Communication between memory 118 and the processor 115 may enable various operations, including but not limited to, data exchange, command execution, and memory management. In accordance with implementations described herein, memory 118 may be used to store data, such as port bandwidth data 124, relating to the usage of the ports 106a-d of the computing system 103, buffer utilization data 127, relating to the usage of the buffer 112 of the computing system 103, and system activity data 130, relating to the usage of the ports 106a-d of the computing system 103.

The memory 118 may be constituted by a variety of physical components, depending on specific type and design. At the core, memory 118 may include one or more memory cells capable of storing data in the form of binary information. These memory cells may be made up of transistors, capacitors, or other suitable electronic components depending on the memory type, such as DRAM, SRAM, or Flash memory. To enable data transfer and communication with other parts of the computing system 103, memory 118 may also include data lines or buses, address lines, and control lines. Such physical components may collectively constitute the memory 118, contributing to its capacity to store and manage data, such as port bandwidth data 124, buffer utilization data 127, and system activity data 130.

Data stored in memory 118 may encompass information about various aspects of port, buffer, and system usage. Such information might include data about active connections, amount of data in queues 121a-d, amount of data in the buffer 112, statuses of each port within the ports 106a-d, among other things. Data may include, for example, buffer-occupancy, a number of active ports 106a-d, a number of total ports 106a-d, and a queue depth or length for each port 106a-d, as described in greater detail herein. The data may be stored, accessed, and utilized by the processor 115 in managing port operations and network communications. For example, the processor 115 might utilize the data in memory 118 to manage network traffic, prioritize, or otherwise control the flow of data through the computing system 103 as described in greater detail herein. Therefore, the memory 118, in potential conjunction with the processor 115, may play a crucial role in optimizing the usage and performance of the ports 106 of the computing system 103.

In one or more embodiments of the present disclosure, a processor 115 of a computing system 103 such as a switch may execute polling operations to retrieve data relating to activity of the ports 106a-d and buffer 112, such as by polling the switching hardware 109. As used herein, polling may involve the processor 115 periodically querying or requesting data from switching hardware 109. The polling process may encompass the processor 115 sending a request to the switching hardware 109 to retrieve desired data. Upon receiving the request, the switching hardware 109 may compile the requested port and/or buffer usage data and send it back to the processor 115.

Data stored in memory 118 may include various metrics such as amount of data or a number of packets in each queue 121a-d, an amount of data or a number of packets in the buffer 112, and/or other information, such as data transmission rates, error rates, and status of each port. The processor 115, after receiving this data, might perform further operations based on the obtained information, such as optimizing port usage, balancing network load, or troubleshooting issues, as described herein.

Data as described herein may include an indication as to one or more groups with which each port 106a-d is associated. As described in greater detail below, ports 106a-d may be grouped based on which destinations are reachable via the ports 106a-d. For example, ports 106a-d which can be used to communicate with a first particular node may be in a first group while ports 106a-d which can be used to communicate with a second particular node may be in a second group. It should be appreciated, as described below, one port 106a-d may be in one or more groups.

Data as described herein may include a current queue depth for each port 106. The current queue depth for a port 106 may be an amount of data, a number of packets, a percentage of used queue space, or other variable which may be used by the processor 115 to determine a usage of each port 106.

In one or more embodiments of the present disclosure, the processor 115 of the computing system 103 may poll data from the buffer 112 to determine a utilization of the buffer 112. Buffer utilization as used herein may represent an amount of data or a number of packets currently stored in the buffer 112 and/or an amount of free space available for data storage in the buffer 112.

The processor 115 may obtain the buffer utilization information by, for example, periodically sending requests to the buffer 112 to retrieve information about the current utilization of the buffer or by periodically reading a register or memory location in which an indication of the amount of data in the buffer is stored. Buffer utilization information may include a number of data packets currently stored in the buffer 112 and/or an amount of free space remaining in the buffer 112.

In some embodiments, the buffer 112, from which the processor 115 polls data, may comprise a memory unit or area designated for temporary storage of data packets waiting to be processed or transmitted. The buffer 112 may also contain or be in communication with control logic or management software which tracks the occupancy status of the buffer 112.

In some embodiments, the processor 115 may perform calculations relating to the buffer utilization. As should be appreciated, the fewer the number of ports 106 are active, the greater the risk of packets being dropped due to the buffer reaching capacity, as the reduced number of egress ports create a bottleneck. Generally speaking, when the buffer utilization is higher or near full, more active ports are needed to reduce the risk of dropping packets.

In one or more embodiments of the present disclosure, the processor 115 of the computing system 103 may execute operations to determine the number of active and inactive ports within the computing system 103 and to determine a system activity level. Active as used herein may indicate that the port is currently engaged in data transmission or reception, while inactive may indicate that the port is not presently involved in data transfer activities.

In some embodiments, the processor 115 may issue requests or commands to components of the computing system 103 such as the switching hardware 109 to fetch an operational status of each port 106a-d or queue 121a-d. Upon receiving these requests, the components may provide the required data to the processor 115. Such data may include the current activity status of each port 106a-d, such as whether the port 106a-d is active or inactive.

In certain embodiments, the processor 115 may also perform computations to calculate a percentage representation of the active ports. Such a calculation may involve dividing the number of active ports by the total number of ports. The obtained percentage may serve as a quantitative measure of the system activity.

System activity as used herein may refer to the percentage of active ports at any given time. System activity may provide an overview of the system's utilization for performance monitoring, system optimization, and capacity planning, such as in accordance with the systems and methods described herein. Generally speaking, when a small percentage of ports are active, the system 103 may be prone to dropping packets or data which bursts occur compared to a scenario where a high percentage of ports are active.

In one or more embodiments of the present disclosure, the processor 115 may use the collected data pertaining to port activity to monitor and maintain a historical bandwidth for each queue 121a-d associated with the ports 106a-d. Such information may be stored in memory 118, such as part of the port data 124 to form a historical record of the port bandwidth. In some implementations, the processor 115 may update the historical bandwidth for each port on a periodic basis. The update frequency may vary depending on specific requirements and design considerations of the system 103. Each update may involve polling the latest port usage data, recalculating the bandwidth, and storing new bandwidth data 124 in the memory 118. The updated data may replace the existing data or be appended to existing data.

In one or more embodiments of the present disclosure, the processor 115, after obtaining the relevant data pertaining to port bandwidth, system activity, historical bandwidth for each port, buffer utilization, and/or other information, may store the information in memory 118 as port bandwidth data 124, buffer utilization data 127, and system activity data 130. Data may comprise, for example, parameters and metrics related to port usage, buffer occupancy, system activity level, and queue depths, among others.

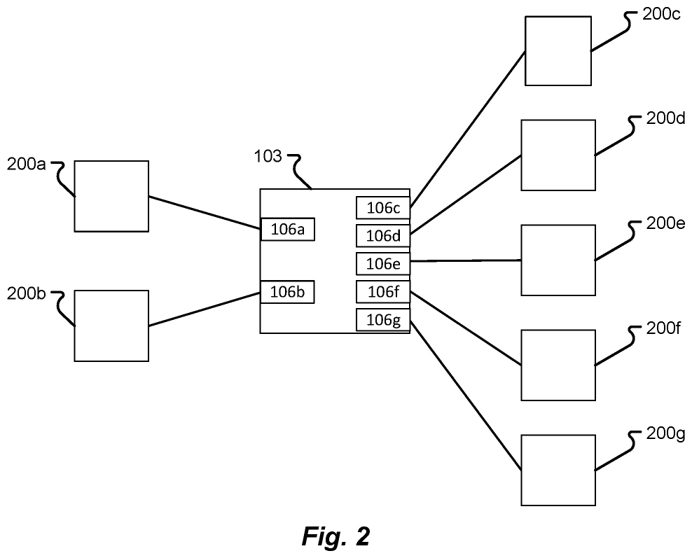

In one or more embodiments of the present disclosure, a computing system 103, such as a switch, may be in communication with a plurality of network nodes 200a-g as illustrated in FIG. 2. Each network node 200a-g may be a computing system with capabilities for sending and receiving data. Each node 200a-g may be any one of a broad range of devices, including but not limited to switches, personal computers, servers, or any other device capable of transmitting and receiving data in the form of packets.

The computing system 103 may establish communication channels with the network nodes 200 via its ports. Such channels may support data transfer in the form of flows of packets, following predetermined protocols that govern the format, size, transmission method, and other aspects of the packets.

Each network node 200a-g may interact with the computing system 103 in various ways. A node 200 may send data packets to the computing system 103 for processing, transmission, or other operations, or for forwarding to another node 200. Conversely, each node 200 may receive data from the computing system 103, originating from either the computing system 103 itself or other network nodes 200a-g via the computing system 103. In this way, the computing system 103 and nodes 200a-g could collectively form a network, facilitating data exchange, resource sharing, and a host of other collaborative operations.

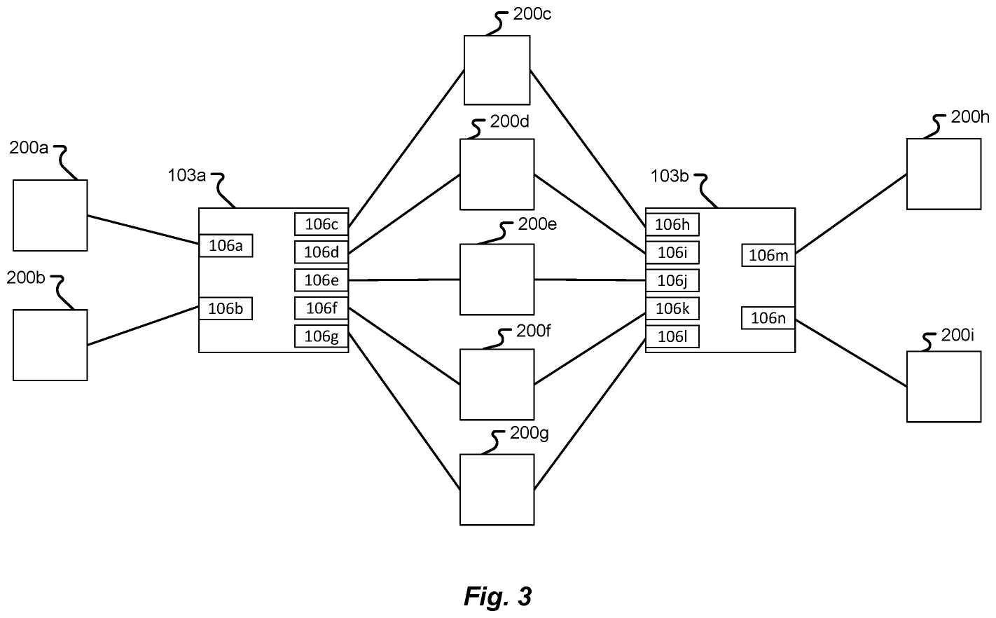

As illustrated in FIG. 3, nodes 200a-i may be connected to a plurality of computing systems 103a-b as described herein forming a network of nodes 200a-i and computing systems 103a-b. For example, the systems and methods described herein may comprise a plurality of interconnected switches. Multiple computing systems 103a-b, such as switches, can be interconnected in a variety of topologies, such as star, ring, or mesh, depending upon the specific requirements and resilience needed for the network. For instance, in a star topology, a plurality of switches may be connected to a central switch, whereas in a ring topology, each switch may be connected to two other switches in a closed loop. In a mesh topology, each switch may be interconnected with every other switch in the network. These robust structures afford a level of redundancy, as there are multiple paths for data to travel, ensuring that network functionality can be maintained even in the event of a switch failure. For example, as illustrated in FIG. 3, for a packet to be sent from node 200a to node 200h, the packet may travel from the computing system 103a to the computing system 103b via any one of nodes 200c-g as computing system 103a is integrated with computing system 103b via multiple ports.

While computing systems 103a and 103b are illustrated as being connected via nodes 200c-g, it should be appreciated the separating nodes 200c-g may be omitted and the computing systems 103a-b may be directly interconnected via any number of one or more ports.

Integrating multiple ports of a first computing system 103a with a second computing system 103b, as opposed to using a single port connection, offers a range of benefits, most prominently increased bandwidth and redundancy. The aggregation of multiple connections between the two switches effectively increases the available data pipeline size, allowing for greater throughput. This is particularly useful in high-demand environments where data traffic is substantial. Furthermore, establishing multiple connections enhances network resilience. If one connection fails, the network can continue operating as usual, utilizing the remaining active connections.

In the example illustrated in FIG. 3, node 200a is connected to port 106a of computing system 103a, node 200b is connected to port 106b of computing system 103a, node 200c is connected to port 106c of computing system 103a and to port 106h of computing system 103b, node 200d is connected to port 106d of computing system 103a and to port 106i of computing system 103b, node 200e is connected to port 106e of computing system 103a and to port 106j of computing system 103b, node 200f is connected to port 106f of computing system 103a and to port 106k of computing system 103b, node 200g is connected to port 106g of computing system 103a and to port 106l of computing system 103b, node 200h is connected to port 106m of computing system 103b, and node 200i is connected to port 106n of computing system 103b. As a result, any of nodes 200a-i can communicate with other of nodes 200a-i via one or both of the computing systems 103a-b. For example, computing system 103a may use any of ports 106c-g to send a packet from node 200a to node 200h or 200i.

Because not every port 106a-g of a computing system 103a may be used to communicate with every possible node 200, each port 106a-g can be considered as being a part of one or more groups of ports based on the nodes which can be served via the port 106a-g. In the example illustrated in FIG. 3, each of ports 106c-g can be used to communicate with nodes 200h and 200i. As such, in FIG. 3, each of ports 106c-g may be in a common group.

Because there may be multiple paths for data to follow to get to a particular destination, one or more ports 106 of a computing system 103 can be activated or deactivated without degrading the flow of data.

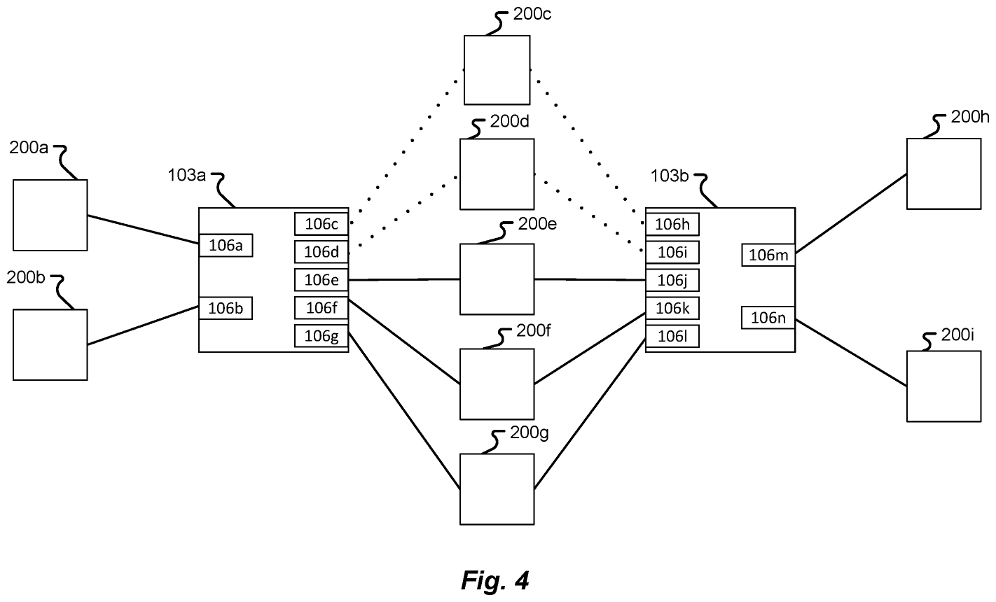

As illustrated in FIG. 3, a flow between node 200a and node 200h can travel through any of ports 106c-g of computing system 103a. If ports 106c and 106d are deactivated, the flow can continue via ports 106e-g. If the data rate does not exceed the capacity of ports 106e-g, the flow can continue essentially unaffected by the deactivated ports 106c and 106d. As illustrated in FIG. 4, the dotted lines connecting port 106c and node 200c, port 106d and node 200d, node 200c and port 106h, and node 200d and port 106i represented deactivated lanes. As should be appreciated, despite these deactivated lanes, other lanes exist to enable communication via any of nodes 200a,b,e,f, g, h, and i.

Because multiple ports 106 of a computing system 103 may lead to the same destination, one or more ports may be unnecessary except in high-traffic situations. Under normal operating situations, ports may either be under used or not used. Using conventional routing methods, traffic is spread evenly across all hardware ports, resulting in a maximum amount of hardware involved in routing decisions, without taking into account the buffer utilization, port bandwidth, and system activity.

On the other hand, using a system as described herein, power efficiency of a computing system, such as in a data center network, can be improved by taking into consideration port bandwidth and bandwidth history, buffer utilization, and system activity, without impacting performance. The systems and methods described herein involve routing traffic using an optimal number of ports, resulting in a reduction of power consumption. Using a system or method as described herein, ports that are not needed can be disabled or deactivated and can be reenabled when additional ports are needed. When a port 106 is active, the port 106 can be among optional ports 106 to send data. A routing mechanism may be capable of selecting an active port 106 to forward a packet and may forward the packet by storing the packet in a queue associated with the active port 106. Disabling, or deactivating, a port 106 as described herein may involve ceasing to forward packets via the port 106 to be disabled. For example, a disabled port 106 may be removed from a list of selectable ports 106 for forwarding packets. Ports 106 of a computing system 103 may be removed from a list of ports capable of being selected for transmitting data such as by masking ports out from a group associated with the destination of the data, resulting in port shut down. In some embodiments, shutting down of a port may occur due to an autonomous port mechanism which may shut down ports. In addition, when traffic is very low, entire switches/devices may enter sleep mode in order to minimize power usage. For example, as illustrated in FIG. 4, nodes 200c and 200d, which may be switches, can be deactivated as computing systems 103a and 103b cease to send packets to the nodes 200c, 200d.

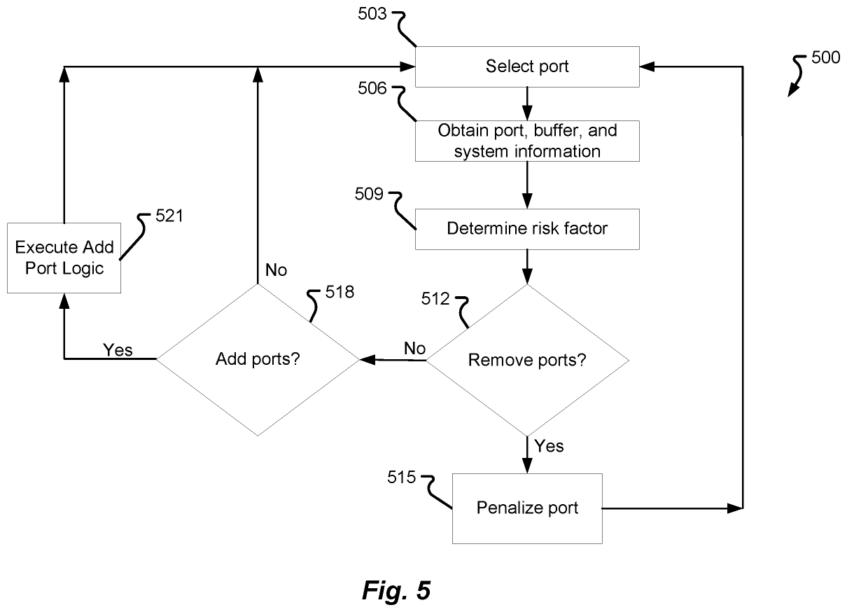

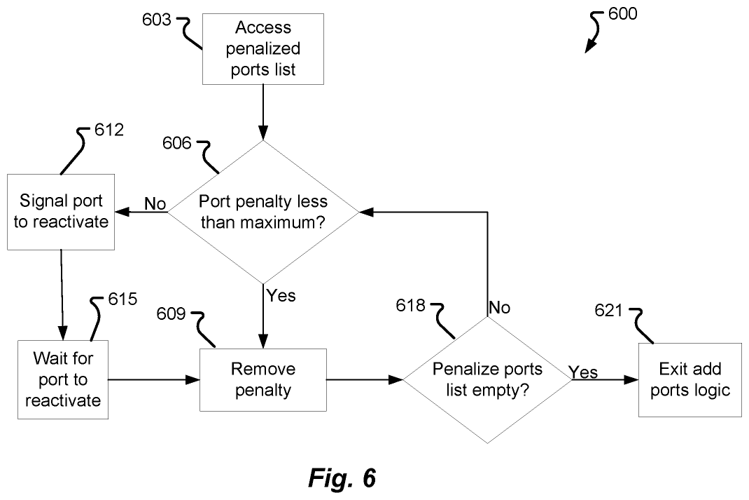

As illustrated in FIG. 5, and in accordance with a computing system 103 as illustrated in FIG. 1 and as described herein, a method 500 may be performed to add or remove ports as needed to reduce power consumption by the computing system 103. While the description of the method 500 provided herein describes the steps of the method 500 as being performed by a processor 115 of the computing system 103, the steps of the method 500 may be performed by one or more processors 115, switching hardware 109, one or more controllers or circuits in the computing system 103, or some combination thereof. As should be appreciated, the method 500 may be implemented through hardware or software. As a result of the method 500, based on current and historical port usage, buffer utilization, system activity, and/or other factors, the computing system 103 may determine one or more ports should be added or removed to enable traffic flows while maximizing power efficiency of the system 103. The adding of ports following the method 500 may be implemented through a method 600 as described below in relation to FIG. 6. The method 500 of FIG. 5, as described below, may be performed separately for each group among the one or more groups of ports. For example, the method 500 may be performed in parallel for each group or may be performed in series for each group.

At 503, the processor 115 of the computing system 103 may iterate through a list of currently active ports. Currently active ports may be ports for which data is being transmitted from the system 103. In some implementations, a list of currently active ports may be stored in memory of the system. The list of currently active ports may be a table or vector with an entry for each port or each active port. Iterating through the list may comprise executing a round-robin mechanism. For example, a round-robin mechanism may begin with a first port and proceed through each of the ports.

Executing round-robin as described herein may involve selecting a first port among a list of currently active ports. The first port may be first in the list or in another position in the list. In some implementations, the first port may be selected randomly. The selected first port may be indicated using a counter, pointer, or register value. As packets are to be sent from the computing system 103, a first packet may be sent via the currently selected port. Once a packet is sent via the selected port, the selected port may increment by one or another value. For example, a counter, pointer, or register value may increase with each packet being sent. A next packet may be sent by the current value of the counter, pointer, or register. Upon the current value of the counter, pointer, or register reaching the end of the list of currently active ports, the counter, pointer, or register may return to the top of the list.

At 506, the processor 115 of the computing system 103 may obtain information associated with port and buffer usage. As described above, the processor 115 of a computing system may be configured to poll data such as a bandwidth history of the port, buffer utilization data, and system activity from switching hardware 109 and/or memory 118. Such information might include data about active ports 106, amount of data in queues 121, amount of data in the buffer 112, statuses of each port within the ports 106a-d, among other things. Port data 124 may include various metrics such as amount of data or a number of packets in each queue 121a-d, an amount of data or a number of packets in the buffer 112, and/or other information, such as data transmission rates, error rates, and status of each port. As an example, information obtained at 506 may include a current bandwidth of a port selected at 503, a bandwidth history of the port selected at 503 and/or other ports, a current buffer utilization, a current system activity or percentage of active ports, and/or other information.

Port data 124 as described herein may include a current queue depth for each port 106. The current queue depth for a port 106 may be an amount of data, a number of packets, a percentage of used queue space, or other variable which may be used by the processor 115 to determine a usage of each port 106.

Port bandwidth history as described herein may include statistics associated with data sent via a respective port over time. For example, port bandwidth history may reflect a total number of packets or a total amount of data sent from a particular port. In some implementations, the port bandwidth history may be a weighted moving average of an amount of data sent from a particular port.

Buffer utilization as described herein may indicate a current amount of data stored in a buffer of the system. In some implementations, the buffer utilization may be a percentage of the capacity of the buffer which is currently occupied with data to be sent from the system.

In one or more embodiments of the present disclosure, the processor 115 of the computing system 103 may poll data from the buffer 112 to determine an occupancy of the buffer 112. The processor 115 may obtain the buffer occupancy information by, for example, periodically sending requests to the buffer 112 to retrieve information about the current occupancy of the buffer or by periodically reading a register or memory location in which an indication of the amount of data in the buffer is stored. Buffer occupancy information may include a number of data packets currently stored in the buffer 112 and/or an amount of free space remaining in the buffer 112.

In some embodiments, the processor 115 may perform calculations relating to the buffer occupancy. For example, buffer occupancy data may be input into a formula by the processor 115 to generate a parameter indicating a risk of dropping packets due to the buffer 112 reaching capacity. As should be appreciated, the fewer the number of ports 106 are active, the greater the risk of packets being dropped due to the buffer reaching capacity, as the reduced number of egress ports create a bottleneck. Generally speaking, when the buffer occupancy is higher or near full, more available ports are needed to reduce the risk of dropping packets.

In one or more embodiments of the present disclosure, the processor 115 of the computing system 103 may execute operations to determine the number of active and inactive ports within the computing system 103. In certain embodiments, the processor 115 may also perform computations to calculate a percentage representation of the active ports. Such a calculation may involve dividing the number of active ports by the total number of ports.

The processor 115 may use the collected data pertaining to port activity to monitor and maintain a historical queue depth for each queue 121a-d associated with the ports 106a-d. Such information may be stored in memory 118, such as part of the port data 124 to form a historical record of the queue depths.

In one or more embodiments of the present disclosure, the processor 115, after obtaining the relevant data pertaining to port usage, port activity, historical queue depth for each queue 121a-d, and/or other information, may store the information in memory 118 as port data 124. System activity as described herein may be an indication of a current number of active ports of the system. In some implementations, the system activity may be a percentage, such as the total number of active ports divided by the total number of ports of the system.

At 509, based on the port data, port bandwidth history, buffer utilization, and system activity, the processor 115 may be capable of determining a risk factor associated with the port selected at 503. The risk factor may be determined by summing one or more of the current port bandwidth, the port bandwidth history, the buffer utilization, and the system activity. Summing the one or more of the current port bandwidth, the port bandwidth history, the buffer utilization, and the system activity may include first multiplying one or more of the current port bandwidth, the port bandwidth history, the buffer utilization, and the system activity by a variable. Multiplying the one or more of the current port bandwidth, the port bandwidth history, the buffer utilization, and the system activity by a variable may enable the one or more of the current port bandwidth, the port bandwidth history, the buffer utilization, and the system activity to be weighted as may be desirable to reflect particular system demands. For example, the risk factor may be the sum of the port bandwidth history multiplied by a first variable, the buffer utilization multiplied by a second variable, and the system activity multiplied by a third variable. Each of the first, second, and third variables may be set based on demands for the system 103 and may be used to effectively weight each of the port bandwidth history, buffer utilization, and system activity for the system 103 when determining whether to add or remove ports.

At 512, the processor may determine whether one or more ports should be removed from the currently active ports. In some implementations, determining whether any ports should be removed from the currently active ports may comprise comparing the risk factor determined at 509 and the current bandwidth for the current port, if not included in the risk factor calculation, to a remove port threshold. In some implementations, comparing a risk factor and a current bandwidth for a port to a remove port threshold may comprise summing the risk factor and the current bandwidth for the port and determining if the sum of the risk factor and the current bandwidth for the port is less than the remove port threshold. As the risk factor and/or the port bandwidth decreases, it becomes more likely that the number of ports necessary for the system is greater than the current number of active ports of the system. On the other hand, as the risk factor and/or the port bandwidth increases, it becomes more likely that the number of ports necessary for the system is less than the current number of active ports of the system.

At 515, if the processor determines one or more ports should be removed from the currently active ports, the processor may add a penalty to the port selected at 503 and/or add the port selected at 503 to list of penalized ports. It should be appreciated that in some implementations, instead of penalizing ports, ports can instead simply be deactivated. A penalty of a port as described herein may be referred to as a configuration of the port. of ports is altered consecutively in a loop. Adding or removing a penalty to or from a port may be referred to as altering the respective configuration of the port. After a configuration of a port has been altered by penalizing the port or removing or reducing a penalty of the port, the configuration of the port may be re-altered by repeating the process of adding or removing ports as described herein.

Penalizing a port may comprise increasing a penalty number associated with the port. For example, in some implementations, routing mechanisms or switching hardware may be configured to select a port to transmit a particular packet based at least in part on a penalty of each port. Ports without penalties may be more likely to be selected than ports with penalties and ports with lower penalties may be more likely to be selected than ports with higher penalties. Ports with a maximum penalty—seven in some implementations—may never be selected for routing a packet or may be selected only in worst case scenarios.

By penalizing a port when the risk factor and the current bandwidth of the port are low, the port will be less likely to be used to send future packets and as a result may be completely deactivated, reducing current power consumption of the system.

After the selected port is penalized at 515, the method 500 may continue with selecting a new port at 503, such as using a round robin mechanism.

If, at 512, the processor determines the sum of the risk factor and the current port bandwidth greater than or equal to the remove ports threshold, at 518 the processor may compare the risk factor and the current bandwidth for the current port to one or more add port thresholds.

Comparing the risk factor and the current bandwidth for the current port to one or more add port thresholds may comprise determining if the sum of the risk factor and the current bandwidth for the current port is greater than the add port threshold.

In some implementations, multiple add port thresholds may be used. For example, a high-risk threshold, a middle risk threshold, and/or a low-risk threshold may be used. In some implementations, after determining the sum of the port bandwidth and the risk factor is greater than an add ports threshold, the method 500 may comprise comparing the risk factor to one or more of a high-risk threshold, middle risk threshold, and/or a low-risk threshold.

The different add port thresholds may be used to determine how many ports should be added or how many penalties of ports should be removed. As described below, if the processor determines the sum of the risk factor and the current bandwidth is greater than the add port threshold, the method 500 may comprise proceeding to 521 and executing add port logic. Add port logic may be a method of removing penalties from ports and may comprise steps such as in the method 600 described below and illustrated in FIG. 6.

If it is determined that the sum of the risk factor and the current bandwidth of the current port are not greater than the add port threshold, the method 500 may comprise returning to 503 to repeat the method with a different port.

In one or more embodiments of the present disclosure, the method 500, after executing, may return to 503 and recommence the process. In some implementations, the repetition of method 500 may occur without delay. In such cases, as soon as the method 500 concludes, the method 500 may immediately begin the next iteration. This arrangement could allow for a continuous execution of method 500. In some implementations, a pause for a predetermined amount of time may occur between successive iterations of method 500. The duration of the pause may be specified as per the operational needs of the method such as by a user.

As illustrated in FIG. 6, a method 600 may be performed in response to a determination that the sum of the port bandwidth and the risk factor are greater than an add port threshold.

At 603, a list of penalized ports may be accessed. The list of penalized ports may be a list of all ports to be added in response to the determination that the sum of the port bandwidth and the risk factor are greater than an add port threshold. In some implementations, the list of penalized ports may be created in response to the determination that the sum of the port bandwidth and the risk factor are greater than an add port threshold.

In some implementations, creating the list of penalized ports may be based on whether the risk factor is above a high, medium, or low risk threshold. For example, the list of penalized ports may include a larger number of ports in response to a determination that the risk factor is above the high-risk threshold, while the list of penalized ports may include a smaller number of ports in response to a determination that the risk factor is above the medium risk threshold and an even smaller number of ports in response to a determination that the risk factor is not above the medium risk threshold. The penalty of each port on the list of penalized ports may, as a result of the method 600, be removed or reduced as described below.

At 606, a determination may be made as to whether a first port on the list of penalized ports has a penalty less than a maximum. If the penalty of the first port on the list of penalized ports has a penalty less than a maximum, the penalty of the first port may be removed at 609 and the port may be removed from the list of penalized ports.

If, at 606, the first port on the list of penalized ports has a maximum penalty, an additional step 612 of signaling to a mechanism that the port should be reactivated may be required. In such an implementation, after signaling to the mechanism that the port should be reactivated, a waiting step 615 until the port is reactivated may be performed. Following the waiting step 615, any penalty associated with the port may be removed at 609 and the port may be removed from the list of penalized ports.

In some implementations, the system may include a mechanism for deactivating ports. When a port reaches a maximum penalty, the mechanism may be activated to execute a process of deactivating the port. Once the port is deactivated, no additional packets may be placed in a queue to be transmitted via the port. The mechanism may also or alternatively control a process of reactivating deactivated ports. When a penalty of a deactivated port at a maximum penalty is removed or reduced, the mechanism may be activated to execute a process of reactivating the port. Once the port is reactivated, packets may be placed in a queue to be transmitted via the port. In such an implementation, it may not be possible or ideal to write a packet to a queue of a deactivated port. As such, the additional step 612 of signaling to the mechanism that the port should be reactivated may enable the mechanism to begin the process of reactivating the port.

At 618, a determination may be made as to whether the list of penalized ports includes any ports. If the list of penalized ports is empty, the method 600 may end at 621.

If the list of penalized ports is not empty, the method 600 may comprise returning to 606 and continuing for a new first port on the list of penalized ports. In some implementations, the methods 500 and 600 may operate on a loop. As the iterations wrap around, the iterations may begin again to repeat for each port. In some implementations, between there may be a sleep or wait period of time between iterations and/or loops, providing a hysteresis mechanism to avoid the constant adding and/or removing of ports.

The present disclosure encompasses methods with fewer than all of the steps identified in FIGS. 5 and 6 (and the corresponding description of the methods), as well as methods that include additional steps beyond those identified in FIGS. 5 and 6 (and the corresponding description of the methods). The present disclosure also encompasses methods that comprise one or more steps from the methods described herein, and one or more steps from any other method described herein.

Embodiments of the present disclosure include a system comprising one or more circuits to: determine, for a first port of a plurality of ports, a bandwidth for the first port and a bandwidth history for the first port; compare the bandwidth for the first port and the bandwidth history for the first port to one or more thresholds; and alter a configuration of the first port based on the comparing of the bandwidth and the bandwidth history to the one or more thresholds.

Embodiments also include a computing system including one or more circuits to: alter a configuration of a first port of a plurality of ports based on a comparison of a bandwidth of the first port, a bandwidth history of the first port, a buffer utilization of the computing system, and a system activity associated with the plurality of ports to one or more thresholds.

Embodiments also include a switch comprising one or more circuits to: determine a system activity and a buffer utilization; determine, for each of a plurality of ports, a bandwidth and a historical bandwidth; compare, for each of the plurality of ports, the bandwidth, the historical bandwidth, the buffer utilization, and the system activity to one or more thresholds; and transmit a packet via one of the plurality of ports based on the comparing, for each of the plurality of ports, of the bandwidth, the bandwidth history, the buffer utilization, and the system activity to the one or more thresholds.

Aspects of the above system, computing system, and switch include wherein altering the configuration of the first port results in a change in power consumption of the system.

Aspects of the above system, computing system, and switch also include wherein the configuration of the first port comprises one or more of a score and a grade of the first port, and wherein altering the configuration of the first port comprises changing the one or more of the score and the grade of the first port.

Aspects of the above system, computing system, and switch include wherein altering the configuration of the first port comprises disabling the first port.

Aspects of the above system, computing system, and switch include wherein altering the configuration of the first port comprises enabling the first port.

Aspects of the above system, computing system, and switch include wherein the one or more circuits are further to determine a system activity, wherein the system activity is a percentage of active ports.

Aspects of the above system, computing system, and switch include wherein the bandwidth history for the first port comprises a moving weighted average.

Aspects of the above system, computing system, and switch include wherein comparing the bandwidth for the first port and the bandwidth history for the first port to one or more thresholds comprises determining a sum of the bandwidth for the first port, the bandwidth history for the first port, a buffer utilization, and a system activity is below one of the one or more thresholds.

Aspects of the above system, computing system, and switch include wherein in response to determining the sum of the bandwidth for the first port, the bandwidth history for the first port, the buffer utilization, and the system activity is below one of the one or more thresholds, adjusting the configuration of the first port comprises disabling the first port.

Aspects of the above system, computing system, and switch include wherein comparing the bandwidth for the first port and the bandwidth history for the first port to one or more thresholds comprises determining a sum of the bandwidth for the first port, the bandwidth history for the first port, a buffer utilization, and a system activity is above one of the one or more thresholds.

Aspects of the above system, computing system, and switch include wherein in response to determining the sum of the bandwidth for the first port, the bandwidth history for the first port, the buffer utilization, and the system activity is above one of the one or more thresholds, adjusting the configuration of the first port comprises enabling the first port.

Aspects of the above system, computing system, and switch include wherein the first port is selected from among the plurality of ports using a round robin algorithm.

Aspects of the above system, computing system, and switch include wherein a respective configuration of each of the plurality of ports is altered consecutively in a loop.

Aspects of the above system, computing system, and switch include wherein after altering the respective configuration of each of the plurality of ports a sleep time elapses before the respective configuration of each of the plurality of ports is re-altered.

Aspects of the above system, computing system, and switch include wherein the one or more circuits are further to: determine, for a second port of the plurality of ports, a bandwidth for the second port and a bandwidth history for the second port; compare the bandwidth for the second port and the bandwidth history for the second port to the one or more thresholds; and adjust a configuration of the second port based on the comparing of the bandwidth for the second port and the bandwidth history for the second port to the one or more thresholds.

Aspects of the above system, computing system, and switch include wherein each of the plurality of ports are eligible for adaptive routing.

Aspects of the above system, computing system, and switch include wherein the one or more circuits are further to send a packet via one of the ports of the plurality of ports based at least in part on a grade of each of the ports.

Aspects of the above system, computing system, and switch include wherein the one or more circuits are further to determine a system activity and a buffer utilization, and wherein altering the configuration of the first port is further based on a comparison of the system activity and the buffer utilization to the one or more thresholds.

It is to be appreciated that any feature described herein can be claimed in combination with any other feature(s) as described herein, regardless of whether the features come from the same described embodiment.

Specific details were given in the description to provide a thorough understanding of the embodiments. However, it will be understood by one of ordinary skill in the art that the embodiments may be practiced without these specific details. In other instances, well-known circuits, processes, algorithms, structures, and techniques may be shown without unnecessary detail in order to avoid obscuring the embodiments.

While illustrative embodiments of the disclosure have been described in detail herein, it is to be understood that the inventive concepts may be otherwise variously embodied and employed, and that the appended claims are intended to be construed to include such variations, except as limited by the prior art.

1. A system for providing adaptive routing, the system comprising one or more circuits to:
determine, for a first port of a plurality of ports, a bandwidth for the first port and a bandwidth history for the first port;
determine a sum of the bandwidth for the first port, the bandwidth history for the first port, a buffer utilization, and a system activity is above or below one or more thresholds; and
alter a configuration of the first port in response to determining the sum is above or below the one or more thresholds.

2. The system of claim 1, wherein altering the configuration of the first port results in a change in power consumption of the system.

3. The system of claim 1, wherein the configuration of the first port comprises one or more of a score and a grade of the first port, and wherein altering the configuration of the first port comprises changing the one or more of the score and the grade of the first port.

4. The system of claim 1, wherein altering the configuration of the first port comprises disabling the first port.

5. The system of claim 1, wherein altering the configuration of the first port comprises enabling the first port.

6. The system of claim 1, further comprising determining a system activity, wherein the system activity is a percentage of active ports.

7. The system of claim 1, wherein the bandwidth history for the first port comprises a moving weighted average.

8. (canceled)

9. The system of claim 1, wherein adjusting the configuration of the first port comprises disabling the first port.

10. The system of claim 1, wherein the one or more circuits are to determine the sum of the bandwidth for the first port, the bandwidth history for the first port, a buffer utilization, and the system activity is above one of the one or more thresholds.

11. The system of claim 10, wherein the one or more circuits are to, in response to determining the sum of the bandwidth for the first port, the bandwidth history for the first port, the buffer utilization, and the system activity is above one of the one or more thresholds, adjust the configuration of the first port comprises enabling the first port.

12. The system of claim 1, wherein the first port is selected from among the plurality of ports using a round robin algorithm.

13. The system of claim 1, wherein a respective configuration of each of the plurality of ports is altered consecutively in a loop.

14. The system of claim 13, wherein after altering the respective configuration of each of the plurality of ports a sleep time elapses before the respective configuration of each of the plurality of ports is re-altered.

15. The system of claim 1, wherein the one or more circuits are further to:
determine, for a second port of the plurality of ports, a bandwidth for the second port and a bandwidth history for the second port;
compare the bandwidth for the second port and the bandwidth history for the second port to the one or more thresholds; and
adjust a configuration of the second port based on the comparing of the bandwidth for the second port and the bandwidth history for the second port to the one or more thresholds.

16. The system of claim 1, wherein each of the plurality of ports are eligible for adaptive routing.

17. The system of claim 1, wherein the one or more circuits are further to send a packet via one of the ports of the plurality of ports based at least in part on a grade of each of the ports.

18. The system of claim 1, wherein the one or more circuits are further to determine the system activity and the buffer utilization.

19. A computing system comprising one or more circuits to:
alter a configuration of a first port of a plurality of ports in response to determining a sum of a bandwidth of the first port, a bandwidth history of the first port, a buffer utilization of the computing system, and a system activity associated with the plurality of ports is above or below one or more thresholds.

20. A switch comprising one or more circuits to:
determine a system activity and a buffer utilization;
determine, for each of a plurality of ports, a bandwidth and a historical bandwidth;
determine a sum, for each of the plurality of ports, of the bandwidth, the historical bandwidth, the buffer utilization, and the system activity is above or below one or more thresholds; and
transmit a packet via one of the plurality of ports in response to determining, for each of the plurality of ports, the sum is above or below the one or more thresholds.
